(19) United States
(12) Patent Application Publication
(10) Pub. No.: US 2018/0267190 A1
(43) Pub. Date: Sep. 20, 2018

(54) METHODS AND SYSTEMS EMPLOYING WINDOWED FREQUENCY SPECTRA ANALYSIS TO DERIVE A SLOWNESS LOG

(71) Applicant: Halliburton Energy Services, Inc., Houston, TX (US)

(72) Inventors: Wei Li, Houston, TX (US); Yao Ge, Houston, TX (US)

(73) Assignee: Halliburton Energy Services, Inc., Houston, TX (US)

(21) Appl. No.: 15/761,326

(22) PCT Filed: Nov. 6, 2015
(86) PCT No.: PCT/US15/59607

§ 371 Date: Mar. 19, 2018

(51) Int. Cl. G01V 1/50; G01V 1/28; G01V 1/30; G01V 1/34

(52) U.S. Cl. CPC G01V 1/50; G01V 1/284; G01V 1/305; G01V 1/34; G01V 2210/1299; G01V 2210/47; G01V 2210/6222; G01V 2210/43; G01V 2210/614; G01V 2210/21

(57) ABSTRACT

A method includes obtaining at least one digital waveform corresponding to acoustic signals collected by a logging tool deployed in a downhole environment. The method also includes performing windowed frequency spectra analysis (WFSA) on the at least one digital waveform to obtain frequency semblance information at different time-slices. The method also includes deriving a slowness log as a function of position using the frequency semblance information.

### BACKGROUND

In the quest for hydrocarbon reservoirs, companies employ many data-gathering techniques, including well logging. The information from well logging results in “logs” (i.e., a table, chart, or graph of measured data values as a function of instrument position). The most sought-after information relates to the location and accessibility of hydrocarbon gases and fluids.

Resistivity, density, and porosity logs have proven to be particularly useful for determining the location of hydrocarbon gases and fluids. These logs are “open hole” logs, i.e., log measurements that are taken before the formation face is sealed with a tubular steel casing. Meanwhile, acoustic logging tools provide measurements of acoustic wave propagation speeds through the formation. There are multiple wave propagation modes that can be measured, including compressional, shear, and Stoneley. Taken together, the propagation speeds of these various modes often indicate formation density and porosity. However, accurate or otherwise useful acoustic logging results are not automatic and are affected at least in part by decisions regarding how acoustic logging measurements are collected and how collected acoustic logging measurements are processed.

One of the issues affecting acoustic logging accuracy is that compressional, shear, and Stoneley waves can be difficult to isolate. For example, compressional and shear wave data, otherwise known as “weak modes” data, can be difficult to analyze in the presence of dominant Stoneley mode wave data.

### BRIEF DESCRIPTION OF THE DRAWINGS

Accordingly, there are disclosed in the drawings and the following description methods and systems employing windowed frequency spectra analysis (WFSA) to derive a slowness log. In the drawings:

FIG. 1 is a schematic diagram showing an illustrative logging-while-drilling (LWD) environment;

FIG. 2 is a schematic diagram showing an illustrative wireline logging environment;

FIG. 3 is a schematic diagram showing an illustrative acoustic logging tool;

FIG. 4 is a graph showing illustrative received waveforms from a logging tool;

FIG. 5 is a block diagram showing illustrative logging tool electronics;

FIG. 6 is a graph showing illustrative waveforms recorded by an acoustic logging tool;

FIG. 7 is a graph showing an illustrative modified Hamming window waveform;

FIG. 8 is a graph showing sliding and slanting Hamming windows as applied to illustrative waveforms;

FIGS. 9A-9L are images of frequency semblance plots at different time-slices obtained using WFSA;

FIG. 10A is a time semblance plot obtained by combining frequency semblance information for different time-slices;

FIG. 10B is a frequency semblance plot obtained by combining frequency semblance information for different time-slices;

FIG. 10C is a frequency semblance plot obtained using a traditional amplitude and phase estimation (APES) technique.

FIG. 11 is a flowchart of an illustrative method involving WFSA.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are methods and systems employing windowed frequency spectra analysis (WFSA) of acoustic signals to derive a slowness log. As used herein, WFSA refers to applying a series of windows to time-domain acoustic signals and transforming each windowed portion or time-slice to the frequency domain. In the frequency domain, a dispersion analysis is performed for each slice, resulting in frequency semblance information at different time-slices. The frequency semblance information for different time-slices can be used to derive a slowness log. Additionally or alternatively, the frequency semblance information for different time-slices can be processed to obtain a time-semblance plot or frequency-semblance plot.

In at least some embodiments, an example method includes obtaining at least one digital waveform corresponding to acoustic signals collected by a logging tool deployed in a downhole environment. The method also includes performing WFSA on the at least one digital waveform to obtain frequency semblance information at different time-slices. The method also includes deriving a slowness log as a function of position using the frequency semblance information. Meanwhile, an example system includes a display and at least one processor in communication with the display. The system also includes at least one memory in communication with the at least one processor. The at least one memory stores instructions that, when executed, cause the at least one processor to obtain at least one digital waveform corresponding to acoustic signals collected by a logging tool deployed in a downhole environment. The instructions further cause the at least one processor to perform WFSA on the at least one digital waveform to obtain frequency semblance information at different time-slices. The instructions further cause the at least one processor to derive a slowness log as a function of position using the frequency semblance information.

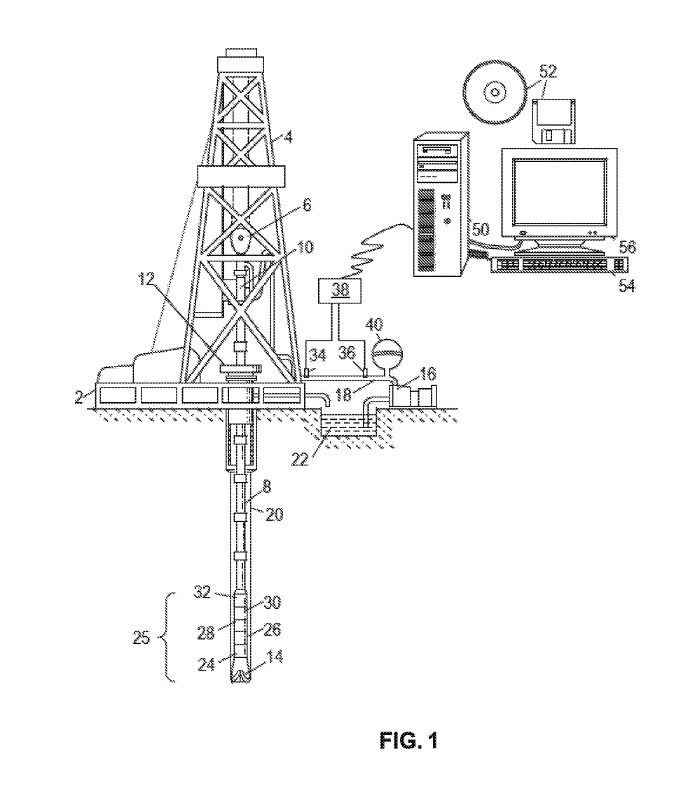

The disclosed systems and methods can be best understood in an application context. Accordingly, FIG. 1 shows an illustrative logging-while-drilling (LWD) environment that includes a drilling platform 2 equipped with a derrick 4 that supports a hoist 6. The rig operator drills an oil or gas well using a drill string 8. The hoist 6 suspends a top drive 10 that rotates the drill string 8 as it lowers the drill string 8 through a wellhead 12. Connected to the lower end of the drill string 8 is a drill bit 14. The bit 14 is rotated and drilling accomplished by rotating the drill string 8, by use of a downhole motor near the drill bit, or by both methods. Recirculation equipment, including mud pump 16, pumps drilling fluid 22 through supply pipe 18, through the top drive 10, and down through the drill string 8 at high pressures and volumes to emerge through nozzles or jets in the drill bit 14. The drilling fluid 22 then travels back up the hole via the annulus formed between the exterior of the drill string 8 and a wellbore wall 20, through a blowout preventer, and into a retention pit 24 on the surface. On the surface, the drilling fluid 22 is cleaned and then recirculated by mud pump 16. The drilling fluid 22 carries cuttings from the base of the bore to the surface and balances the hydrostatic pressure in the rock formations.

At the lowermost part of drill string 8, a bottomhole assembly (BHA) 25 includes thick-walled tubulars called drill collars, which add weight and rigidity to aid the drilling process. The thick walls of these drill collars make them useful for housing instrumentation and LWD sensors. Thus, for example, the BHA 25 may include a natural gamma ray detector 24, a resistivity tool 26, an acoustic logging tool 28, a neutron porosity tool 30, and/or a control/telemetry module 32. Other tools and sensors can also be included in the BHA 25 such as position sensors, orientation sensors, pressure sensors, temperature sensors, vibration sensors, etc. From the various BHA tools and sensors, the control/telemetry module 32 collects data regarding the formation properties and/or various drilling parameters, and stores the data in internal memory. In addition, some or all of the data is transmitted to the surface by, e.g., mud pulse telemetry, acoustic telemetry, electromagnetic telemetry, etc.

In a mud pulse telemetry example, the telemetry module 32 modulates a resistance to drilling fluid flow to generate pressure pulses that propagate to the surface. One or more pressure transducers 34, 36 (isolated from the noise of the mud pump 16 by a desurger 40 ) convert the pressure signal into electrical signal(s) for a signal digitizer 38. The digitizer 38 supplies a digital form of the pressure signals to a computer 50 or some other form of a data processing device. Computer 50 operates in accordance with software (which may be stored on information storage media 52 ) and user input received via an input device 54 to process and decode the received signals. The resulting telemetry data may be further analyzed and processed by computer 50 to generate a display of useful information on a computer monitor 56 or some other form of a display device.

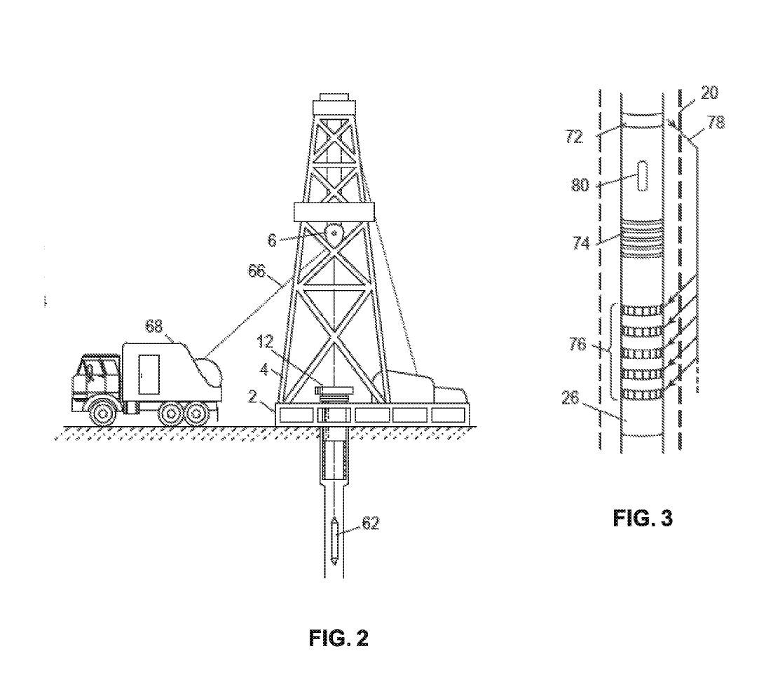

At various times during the drilling process, the drill string 8 may be removed from the wellbore and replaced with a wireline logging assembly as shown in FIG. 2. Once the drill string has been removed, logging operations can be conducted using a wireline tool string 62, i.e., a sensing instrument sonde suspended by a cable 66 having conductors for conveying power to the wireline tool string 62 and telemetry between the wireline tool string 62 and earth's surface. The wireline tool string 62 can include an acoustic logging tool to collect acoustic signals as described herein. Other formation property sensors can additionally or alternatively be included to measure formation properties as the wireline tool string 62 is pulled uphole. A logging facility 68 collects measurements from the wireline tool string 62 and includes computing facilities for processing and storing the measurements gathered by the logging tool. In at least some embodiments, logging facility 68 employs windowed frequency spectra analysis of acoustic signals to derive a slowness log and/or to perform other operations as described herein.

FIG. 3 shows an illustrative LWD embodiment of acoustic logging tool 26 in a wellbore 20. The wireline tool string 62 may include similar components. As shown, the logging tool 26 includes a monopole acoustic source 72, an acoustic isolator 74, an array of acoustic receivers 76, and a multi-pole source 80. The multi-pole source 89 may be a dipole, crossed-dipole, quadrupole, hexapole, or higher-order multi-pole transmitter. Some tool embodiments may include one acoustic source that is configurable to generate different wave modes rather than having separate transmitter sources, but in each case the source(s) are designed to generate acoustic waves 78 that propagate through the formation and are detected by the receiver array 76. The acoustic sources 72 and 80 may be made up of piezoelectric elements, bender bars, or other transducers suitable for generating acoustic waves in downhole conditions. The contemplated operating frequencies for the acoustic logging tool are in the range between 0.5 kHz and 30 kHz, inclusive. The operating frequency may be selected on the basis of a tradeoff between attenuation and wavelength in which the wavelength is minimized subject to requirements for limited attenuation. Subject to the attenuation limits on performance, smaller wavelengths may offer improved spatial resolution of the tool.

The acoustic isolator 74 serves to attenuate and delay acoustic waves that propagate through the body of the tool from the source 72 to the receiver array 76. Any standard acoustic isolator may be used. Although five receivers are shown in FIG. 3, the number can vary from one to sixteen or more. When the acoustic logging tool is enabled, the internal controller controls the triggering and timing of the acoustic source 72 and records and processes the signals from the receiver array 76. An internal controller fires the acoustic source 72 periodically, producing acoustic pressure waves 78 that propagate through the fluid in wellbore 20 and into the surrounding formation. As these pressure waves 78 propagate past the receiver array 76, they cause pressure variations that can be detected by the receiver array elements 76. The receiver array signals may be processed by the internal controller to determine the true formation anisotropy and shear velocity, or the signals may be communicated to an uphole computer system for processing. The measurements are associated with wellbore position (and possibly tool orientation) to generate a log or image of the acoustical properties of the wellbore. The log or image is stored and ultimately displayed for viewing by a user. In at least some embodiments, acoustic signals collected by an acoustic logging tool such as logging tool 26 are analyzed using a WFSA to derive a slowness log and/or to perform other operations as described herein.

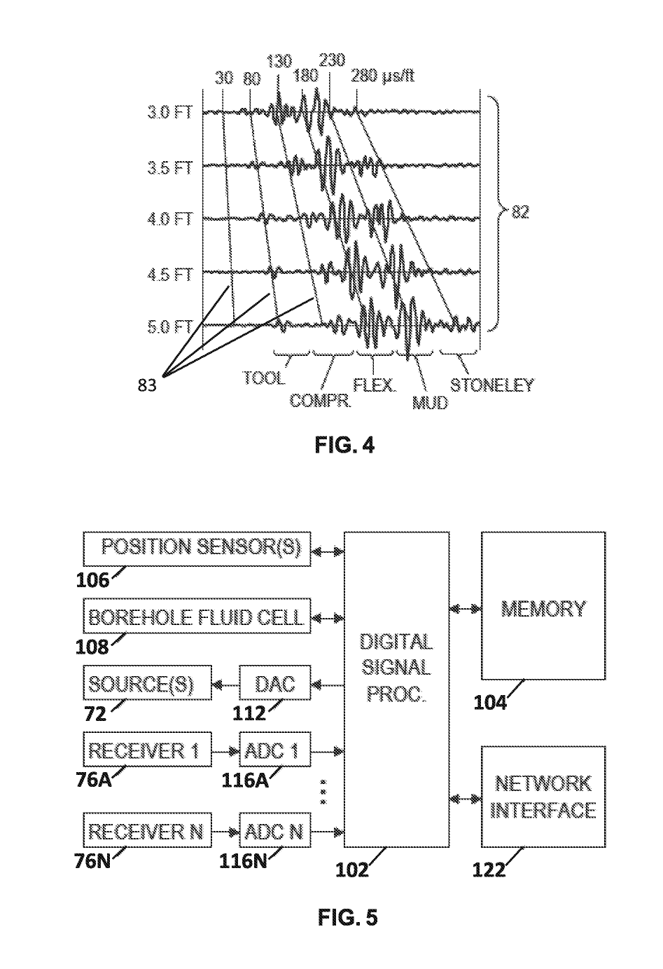

FIG. 4 shows a set of illustrative time-domain waveforms 82, where the time scale is from 0 to 1500 μs. The waveforms 82 may be detected, for example, by the receiver array 76 of FIG. 3 in response to triggering one of the acoustic sources 72 or 80 (see FIG. 3). In FIG. 4, the receivers are located at 3, 3.5, 4, 4.5, and 5 ft. from the acoustic source, and various slowness value slope lines 83 are shown to aid in interpretation. (Note the increased time delay before the acoustic waves reach the increasingly distant receivers.) After recording the waveforms 82, an acoustic logging controller may normalize the waveforms 82 so that they have the same signal energy.

The waveforms 82 represent multiple waves, including waves propagating through the body of the tool (“tool waves”), compression waves from the formation, shear waves from the formation, waves propagating through the wellbore fluid (“mud waves”), and Stoneley waves propagating along the wellbore wall. Each wave type has a different propagation velocity which separates them from each other and enables their velocities to be independently measured.

The receiver array signals may be processed by a downhole controller to determine parameters such as Vs (the formation shear wave velocity) and Vc (the formation compression wave velocity), or the signals may be communicated to an uphole computer system for processing. Though the term “velocity” is commonly used, the measured value is normally a scalar value, i.e., the speed. The speed (velocity) can also be equivalently expressed in terms of slowness, which is the reciprocal of speed. When the velocity is determined as a function of frequency, the velocity may be termed a “dispersion curve”, as the variation of velocity with frequency causes the wave energy to spread out as it propagates.

As desired, acoustic velocity or slowness measurements may be associated with wellbore position (and possibly tool orientation) to generate a log or image of the acoustic properties of the wellbore. The log or image is stored and/or displayed for viewing by a user. In at least some embodiments, deriving such acoustic velocity or slowness logs involves WFSA as described herein.

FIG. 5 is a functional block diagram of the electronics associated with acoustic logging. Such electronics may be included, for example, with logging tool 26 or wireline tool string 52. As shown, the electronics include a digital signal processor 102 that may operate as an internal controller by executing software stored in memory 104. In some embodiments, the processor 102 directs collection of measurements from various measurement modules such as position sensor 106 and borehole fluid cell 108. Alternatively, position sensor 106 and borehole fluid cell 108 may be implemented as separate tools in a wireline sonde or bottomhole assembly.

The processor 102 also may direct firing of acoustic source(s) 72. As needed, a digital-to-analog converter 112 may be employed between the processor 102 and the acoustic source(s) 72. In response to firing acoustic source(s) 72, the processor 102 may obtain acoustic signals from receiver array 76A-76N via analog-to-digital converters 116A-116N. The digitized acoustic signals can be stored in memory 104 and/or processed to determine compression, shear, and Stoneley wave velocity or slowness values. In accordance with at least some embodiments, the processor 102 employs WFSA to derive a velocity or slowness log as a function of position. Alternatively, acoustic signals can be communicated to a control module or a surface processing facility, where WFSA is employed to derive a velocity or slowness log as a function of position. For example, a network interface 122 coupled to the processor 102 may enable acoustic signals or WFSA results to be communicated to an uphole processor and/or to a surface processing facility. Additionally or alternatively, the network interface 122 enables new commands or instructions to be provided to the processor 102 and/or memory 104 (e.g., activating tool components and/or changing operating parameters). The processor 102 may be used to employ WFSA operations by executing software.

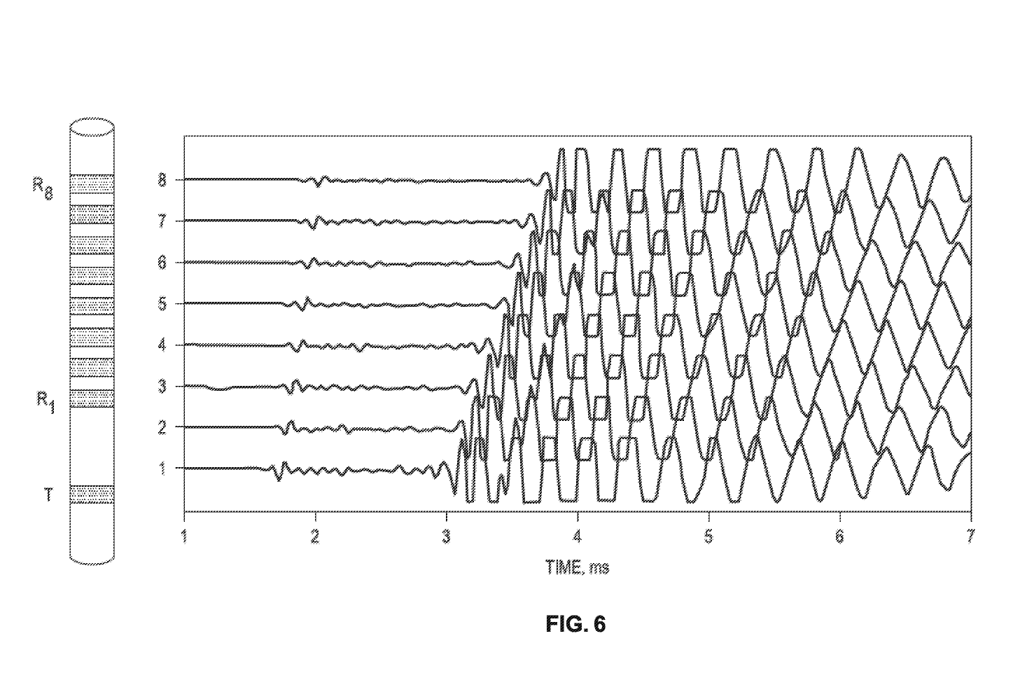

In at least some embodiments, WFSA operations can be performed on recorded waveforms collected by an acoustic logging tool (e.g., an Array Sonic Tool). For example, FIG. 6 shows an example acoustic logging tool with a transmitter (T) and eight equidistant receivers (R₁ to R₈). FIG. 6 also shows illustrative waveforms recorded by receivers R₁ to R₈. For different acoustic logging tools, is should be appreciated that the quantity and spacing of transmitters and of receivers may vary. Regardless of the number of receivers, recorded waveforms can be represented as xₙ (t) (n=1, . . . , N).

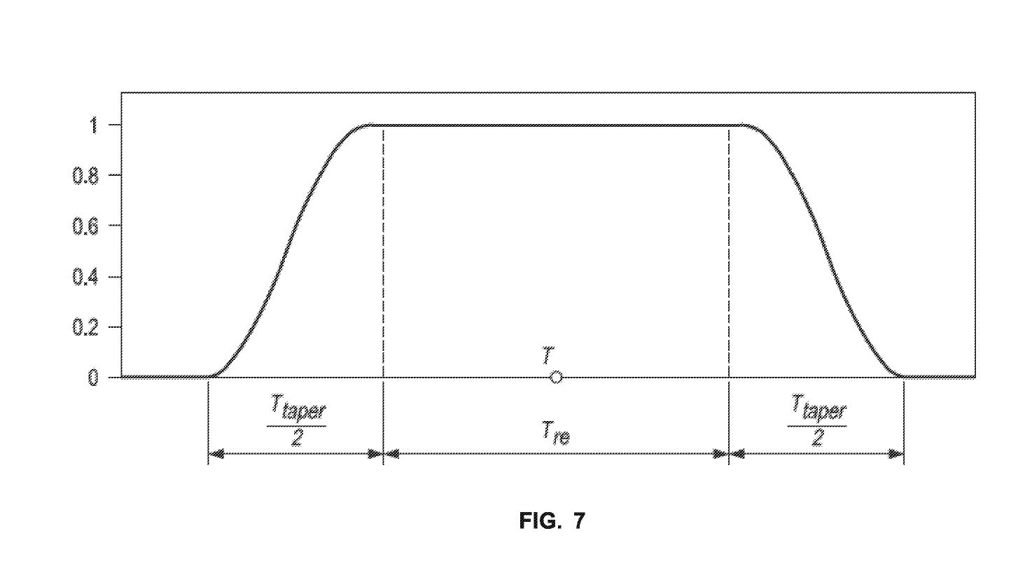

In the recorded waveforms represented in FIG. 6, the weak refracted shear arrival is difficult to discern. To identify the shear head wave from such a data set, WFSA operations are performed and may include filtering out the influence from other higher-amplitude waves (e.g. Stoneley waves) in the time domain. Such filter may be performed, for example, using a bank of modified Hamming windows, wₙ (T, S). For example, a traditional Hamming window may be split into two symmetric parts and is added to the two sides of a rectangular window. In such case, the windows are functions of two parameters, time location T and slanting angle S, which can be expressed as a formula:

$$Equation ( 1 )$$

$$\{ \begin{matrix}\begin{matrix}{w}_{n} ( T , S ) = 0.5 ( 1 - cos \frac{π ( t - T + S ( n - 1 ) d )}{{T}_{taper} / 2} ) - \\ {T}_{taper} / 2 - {T}_{re} / 2 < t - T < - {T}_{re} / 2\end{matrix} & 1 - {T}_{re} / 2 ≪ t - T ≪ {T}_{re} / 2 \\ {w}_{n} ( T , S ) = 0.5 ( 1 + cos \frac{π ( t - T + S ( n - 1 ) d )}{{T}_{taper} / 2} ) & {T}_{re} / 2 < t - T < {T}_{re} / 2 + {T}_{taper} / 2 \\ 0 & otherwise\end{matrix} ,$$

where T is the center of the window; S is the scanning slowness (indicating the slanting angle of the window); d is the receiver spacing; n is the receiver number (1 to N); Tᵣₑ is the width of the rectangular window; and Tₜₐₚₑᵣ is the width of the Hamming window. FIG. 7 shows an illustrative modified Hamming window waveform of the first receiver with a time center T.

FIG. 8 represents sliding and slanting modified Hamming windows applied to the recorded waveforms of FIG. 6. In at least some embodiments, WFSA operations involve applying a series of modified Hamming windows to recorded waveforms and transferring the windowed waveforms to the frequency domain. The windowed frequency spectra are then obtained as:

Xₙ(ω, T, S)=∫_{T-T}_{_{w}}_{/2}^{T+T}^{_{w}}^{/2}wₙ(t,S)xₙ(t+S(n−1)d)e^{-jωt}dt, Equation (2)

where T_{w}=Tₜᵣₐₚₑᵣ+Tᵣₑ; xₙ(t) is the n^{th} record in time domain; Xₙ(ω, T, S) is the n^{th} frequency spectra filtered with a window wₙ(T, S); and ω is the angular frequency. From the physical mechanism of wave propagation in a wellbore, the spectra Xₙ(ω, T, S) can also be expressed as a sum of P harmonic signals with complex amplitudes as:

$${X}_{n} ( ω , T , S ) = {\sum }_{p = 1}^{P} {α}_{p} {e}^{- j ω {s}_{p} ( n - 1 ) d} + {v}_{n} ( ω ) , \\ n = 1 , 2 , … , N \qquad Equation ( 3 )$$

Assuming a Finite Impulse Response (FIR) filter w of order M (where M<N) is given by a vector of coefficients: w=[w₁, w₂, . . . , w_{M}]^{T}, the windowed spectral data can be re-formed into L=N−M+1 subvectors as:

xₙ=[Xₙ, Xₙ₊₁, . . . , X_{n+M-1}]^{T}, 1≤n≤N−M+1. Equation (4)

Then the filter output could be written as:

yₙ=w^{H}xₙ=xₙ^{T}w*, Equation (5)

where [⋅]^{H}, [⋅]^{T}, [⋅]* stand for conjugate transposition, matrix transposition, and complex conjugation, respectively. To deeply suppress the interference and noise, the filter is designed so that its output is to be as close as possible to the sinusoid with specialized slowness. An objective function that constrains the sinusoids and that passes the filter without distortion may be expressed as:

$${min}_{w , α} J ( w , α ) subject to {w}^{H} a ( s ) = 1 , \qquad Equation ( 6 )$$

where α(s)=[1, e^{-jωsd}, . . . , e^{-jωs(M-1)d}]^{T} is a steering vector and the objective function may correspond to:

$$J ( w , α ) {=}^{Δ} E \{ {\vert {w}^{H} {x}_{n} - α {e}^{- j ω s ( n - 1 ) d} \vert}^{2} \} = \frac{1}{L} {\sum }_{n = 1}^{N - M + 1} {\vert {w}^{H} {x}_{n} - α {e}^{- j ω s ( n - 1 ) d} \vert}^{2} . \qquad Equation ( 7 )$$

If

$$g ( s ) = \frac{1}{L} {\sum }_{n = 1}^{n = N - M + 1} {x}_{n} {e}^{j ω s ( n - 1 ) d} , \hat{Q} ( s ) = \hat{R} ( s ) - g ( s ) {g}^{H} ( s ) , and$$

$$\hat{R} ( s ) = \frac{1}{L} {\sum }_{n = 1}^{n = N - M + 1} {x}_{n} {x}_{n}^{H} ,$$

then the solution of the above constrained minimization problem is the optimal filter vector along with the estimate of the amplitude of the filtered signal given by:

$${\hat{w}}_{APES} ( s ) = \frac{{\hat{Q}}^{- 1} ( s ) a ( s )}{{a}^{H} ( s ) {\hat{Q}}^{- 1} ( s ) a ( s )} , \\ {\hat{α}}_{APES} ( s ) = \frac{{a}^{H} ( s ) {\hat{Q}}^{- 1} ( s ) g ( s )}{{a}^{H} ( s ) {\hat{Q}}^{- 1} ( s ) a ( s )} \qquad Equation ( 8 )$$

Here the estimate \hat{α}_{APES} (s) is a function of the slowness, s, and the absolute value of this estimate equal to |α|, the amplitude related to the mode of slowness s in the harmonic model defined by Equation (3). When s=sₚ, and p=1,2, . . . , P, funtion |\hat{α}(s)| attains a local maximum, while for other slownesses |\hat{α}(s)| is close to zero. Therefore, one can use |\hat{α}(s)| as an indicator of the presence of a particular mode in the signal. However, since the spectra Xₙ(ω, T, S) already contain the information of slowness, S, it is not necessary to scan all the slownesses when estimating the amplitudes for each frequency. By substituting each s in Equations 7 and 8 with S, the corresponding amplitude and phase within the designated window can be estimated. In at least some embodiments, WFSA operations involves repeating the procedure represented by Equations 2 to 8 for each discrete frequency, thereby delivering the dispersion relationship (slowness versus frequency) at different time-slices for the analyzed signals.

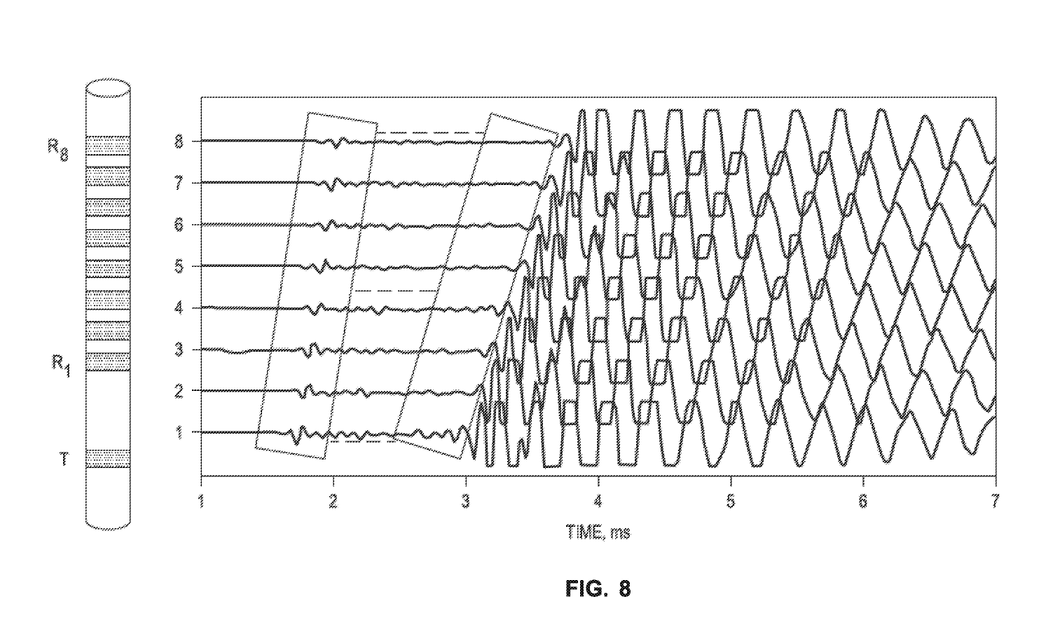

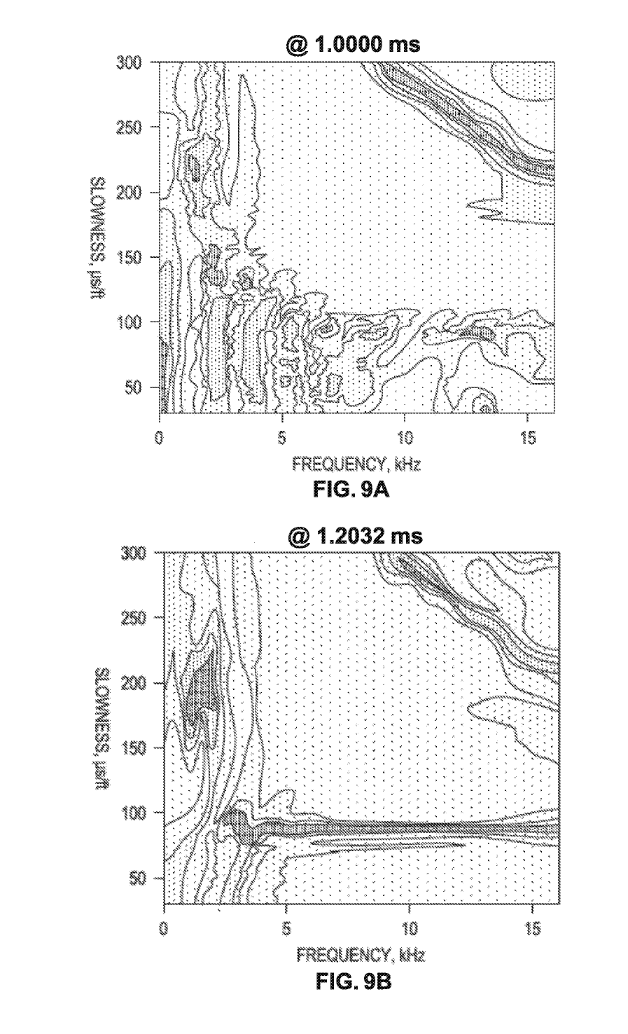

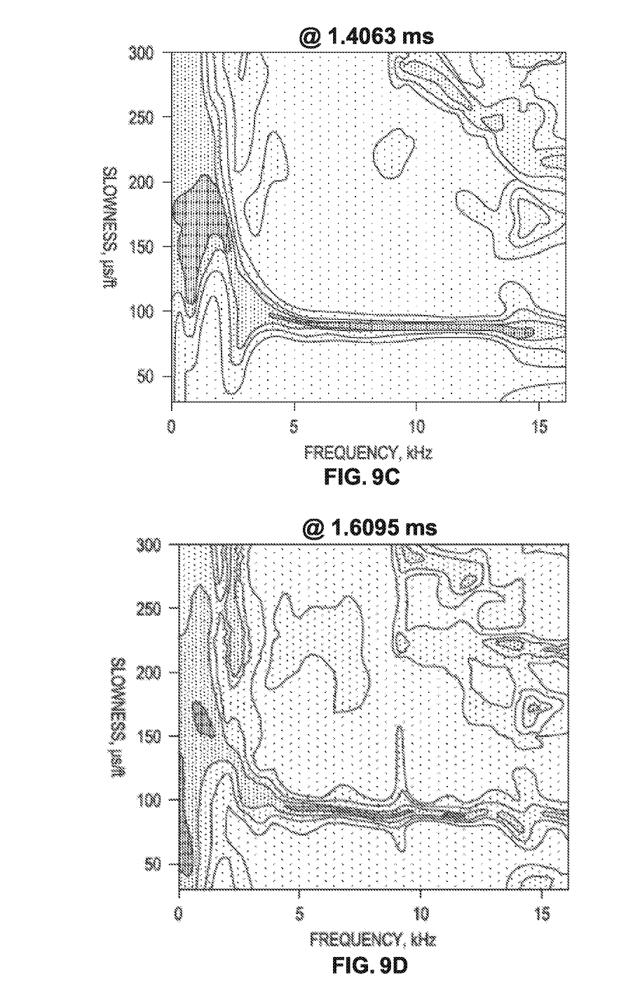

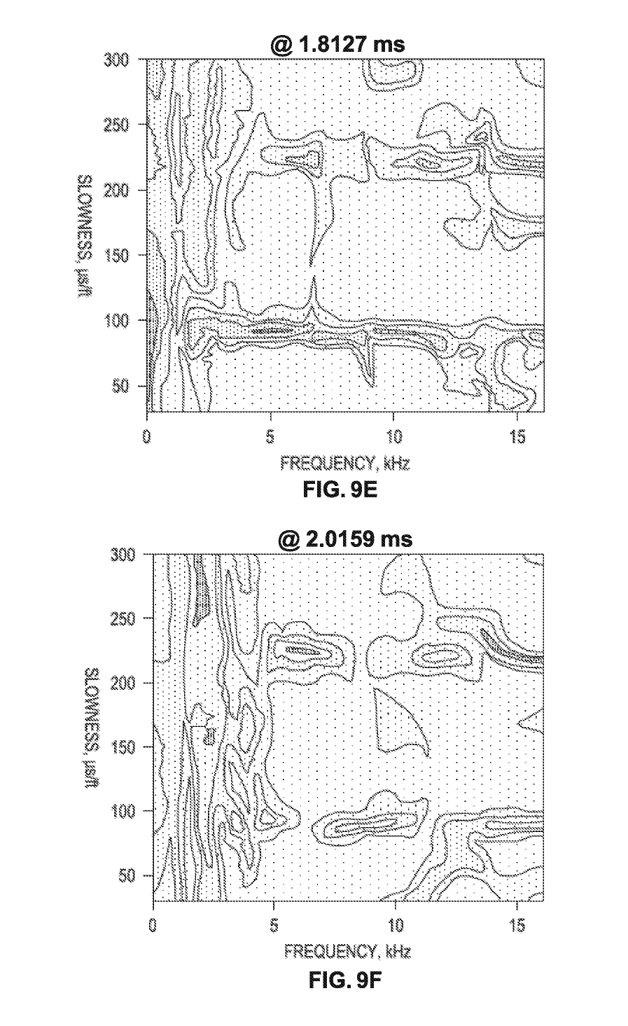

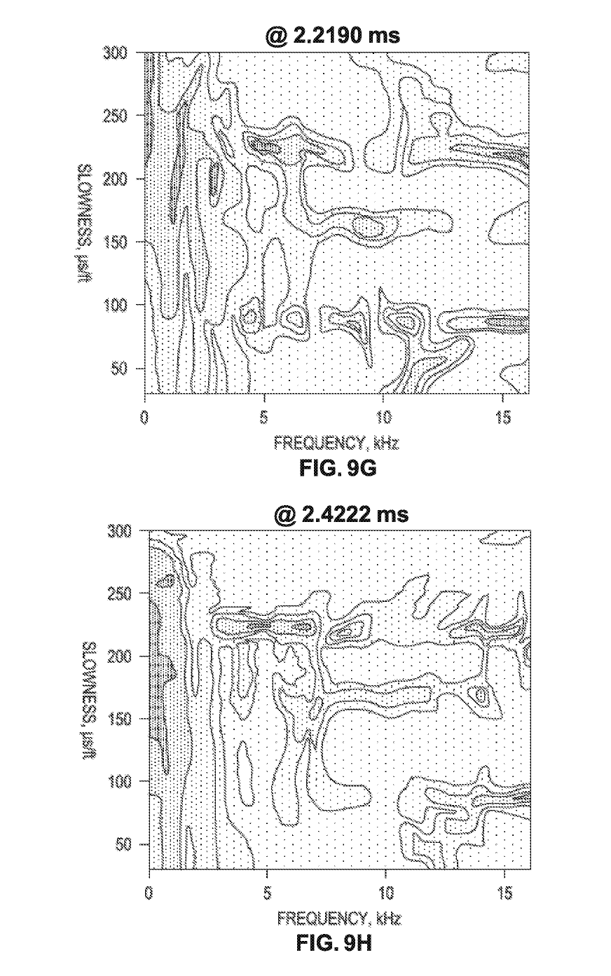

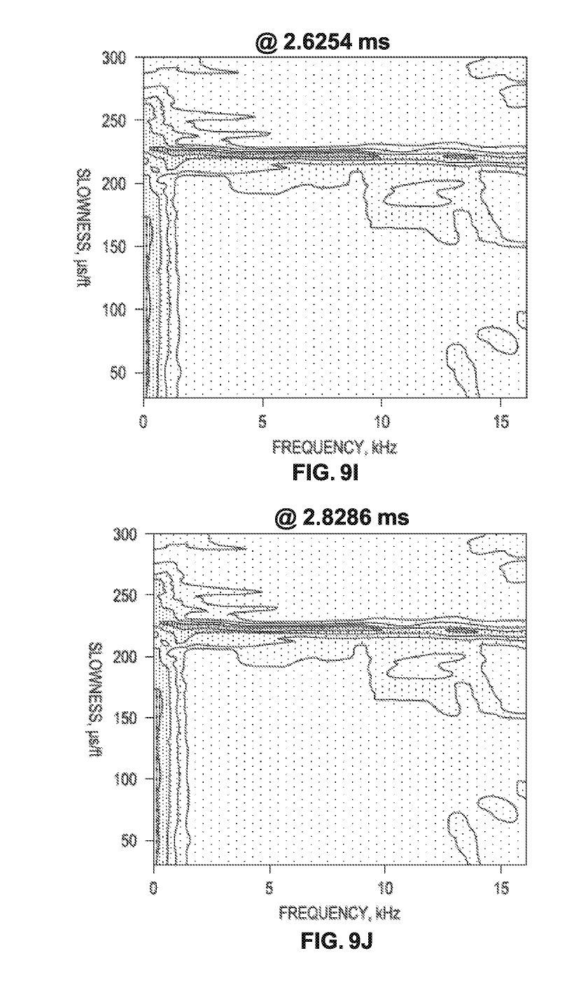

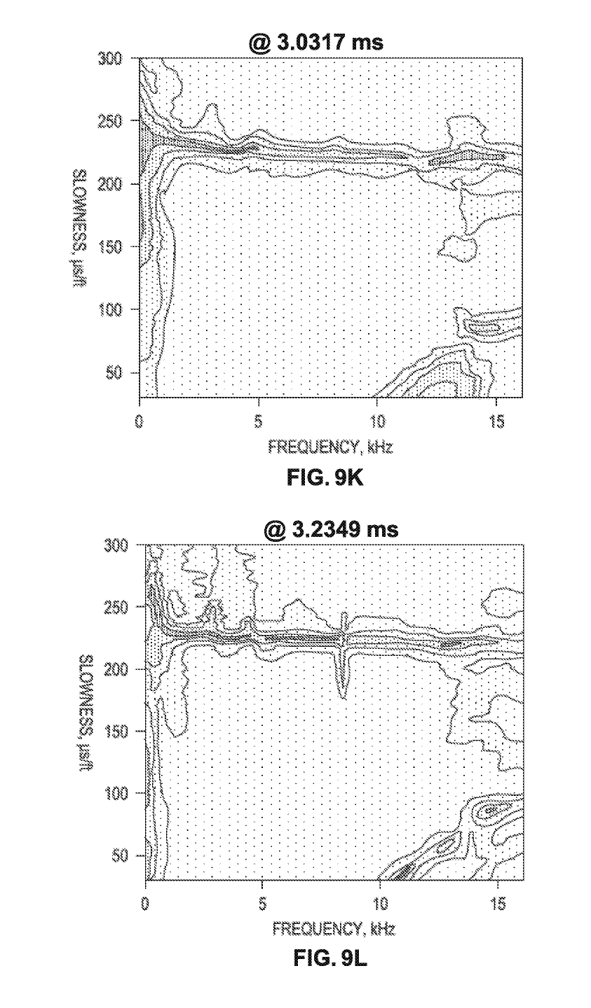

FIGS. 9A-9L are illustrative frequency semblance plots at different time-slices obtained using WFSA as described herein. The time-slices corresponds to twelve discrete time values ranging from 1.0000 ms to 3.2349 ms. In at least some embodiments, frequency semblance plots at different time-slices may be analyzed to determine slowness values related to different propagation modes. For example, while definitive slowness values are difficult to ascertain using the frequency semblance plots of FIGS. 9A and 9E-H, the other frequency semblance plots provide meaningful information. More specifically, a slowness value of around 85 μs/ft can be seen in FIGS. 9B-9D (from about 1.2 ms to about 1.6 ms) and corresponds to the compressional mode. Meanwhile, another slowness value of around 225 μs/ft can be seen in FIGS. 9I-9L (from about 2.6 ms to about 3.2 ms) and corresponds to the shear mode. The slowness values obtained from analysis of frequency semblance plots at different time-slices can be used to generate a slowness log as a function of position. These slowness logs can be used to characterize a formation, to perform seismic analysis, and/or other operations.

In at least some embodiments, the frequency semblance information at different time-slices can be combined to obtain a frequency semblance plot or time semblance plot that shows slowness values of interest. As an example, a time semblance plot that combines frequency semblance information at different time-slices can be generated using:

$$α ( s , t ) = {\sum }_{f = {f}_{0}}^{{f}_{max}} \vert α ( s , t , f ) \vert \qquad Equation ( 9 )$$

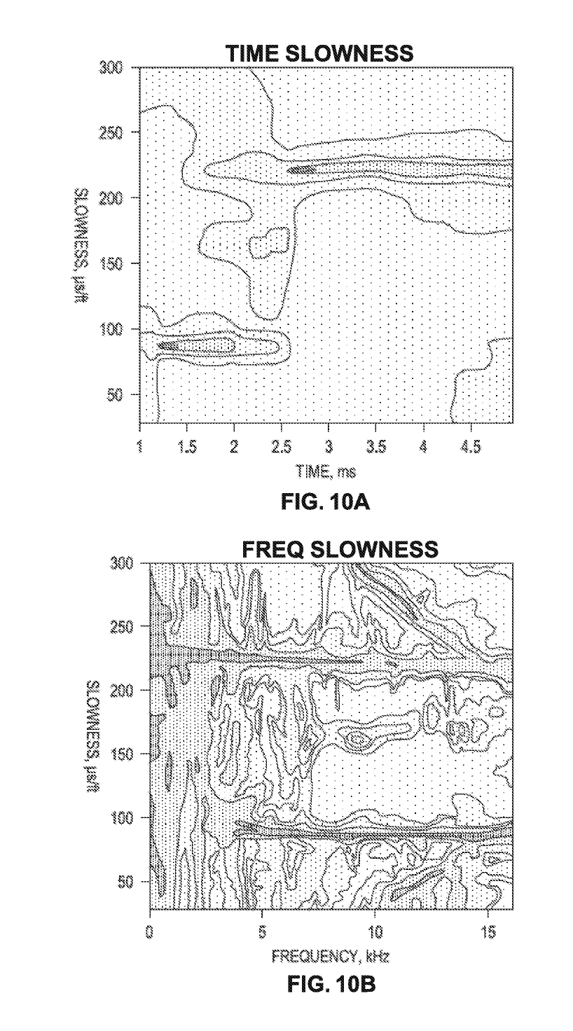

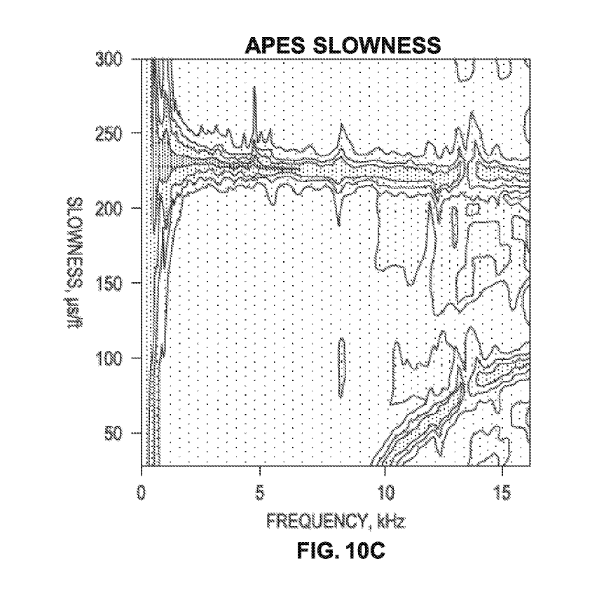

FIG. 10A illustrates an example time semblance plot obtained using Equation 9 and the frequency semblance information represented in FIGS. 9A-9L. Meanwhile, a frequency semblance plot that combines frequency semblance information at different time-slices can be generated using:

$$α ( s , f ) = {max}_{t} \vert α ( s , t , f ) \vert \qquad Equation ( 10 )$$

FIG. 10B is a frequency semblance plot obtained using Equation 10 and the frequency semblance information represented in FIGS. 9A-9L. In FIGS. 10A and 10B, the slowness values of interest (85 μs/ft and 225 μs/ft) can be seen clearly. For comparison, FIG. 10C illustrates a frequency semblance plot generated using a known amplitude phase estimation (APES) technique. In FIG. 10C, the shear mode slowness cannot be ascertained clearly, resulting in a less accurate slowness log, less accurate seismic tie-in, etc.

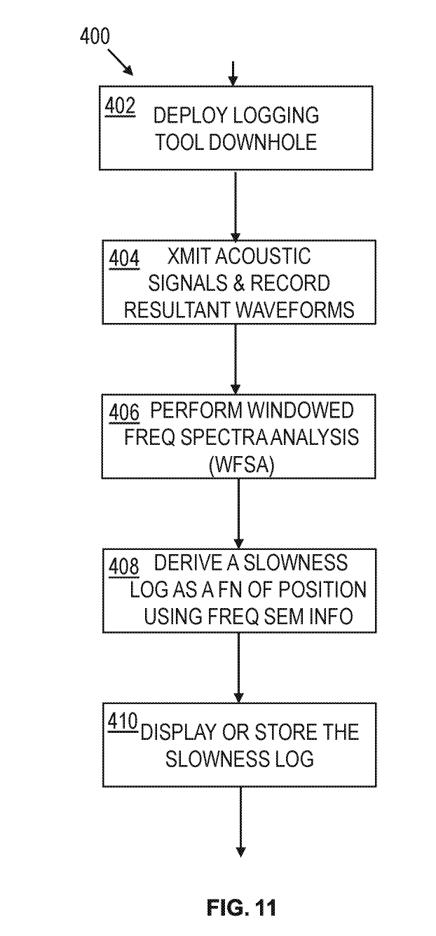

FIG. 11 is a flowchart of an illustrative acoustic logging and data analysis method 400. The flowchart 400 may be employed for each of a plurality of positions in a borehole. The operations described for method 400 may be performed downhole and/or at earth's surface. In block 402, a logging tool is deployed or repositioned downhole as part of a LWD tool or wireline tool assembly. The position of the logging tool along the wellbore is determined and logged. At block 404, acoustic signals are transmitted and resulting waveforms are recorded using the deployed logging tool. As an example, transmitted acoustic signals may propagate in the compressional, shear, and Stoneley wave modes, and an array of receivers records corresponding waveforms as they arrive to the receivers. In block 406, WFSA is performed. In at least some embodiments, performing WFSA involves filtering digital acoustic signals using a filter bank to obtain frequency semblance information at different time-slices, where the filter bank corresponds to a rectangular window and a split Hamming window. Other WFSA operations include converting the windowed portions of the acoustic signals to the frequency domain and applying an objective function. With the WFSA operations of block 406, frequency semblance information at different time-slices is obtained. At block 408 a slowness log is derived as a function of position using the frequency semblance information obtained in block 406. As described herein, slowness values can be obtained by analysis of frequency semblance information at different time-slices, by combining frequency semblance information at different time-slices to obtain a frequency semblance plot, and/or by combining frequency semblance information at different time-slices to obtain a time semblance plot. At block 410, the slowness log derived at block 408 may be displayed or stored. The slowness log may be associated with one or more of a compressional mode, a shear mode, and a Stoneley mode as a function of measured depth. Such slowness logs can be used to characterize formation layers or bed boundaries. Further, seismic data analysis may be performed, in part, on the slowness values in such slowness logs.

Embodiments disclosed herein include:

A: A method that comprises: obtaining at least one digital waveform corresponding to acoustic signals collected by a logging tool deployed in a downhole environment; performing WFSA on the at least one digital waveform to obtain frequency semblance information at different time-slices; and deriving a slowness log as a function of position using the frequency semblance information.

B: A system that comprises: a display; at least one processor in communication with the display; at least one memory in communication with the at least one processor, the at least one memory storing instructions that, when executed, causes the at least one processor to: obtain at least one digital waveform corresponding to acoustic signals collected by a logging tool deployed in a downhole environment; perform WFSA on the at least one digital waveform to obtain frequency semblance information at different time-slices; and derive a slowness log as a function of position using the frequency semblance information.

Each of embodiments A and B may have one or more of the following additional elements in any combination: Element 1: wherein performing WFSA comprises filtering the at least one digital waveform using a filter bank. Element 2: wherein the filter bank corresponds to a rectangular window and a split Hamming window. Element 3: wherein performing WFSA further comprises converting windowed portions of the at least one digital waveform to the frequency domain. Element 4: wherein performing WFSA further comprises applying an objective function to the at least one digital waveform. Element 5: further comprising combining the frequency semblance information at different time-slices to obtain a frequency semblance plot. Element 6: further comprising combining the frequency semblance information at different time-slices to obtain a time semblance plot. Element 7: further comprising displaying or storing the slowness log. Element 8: further comprising collecting acoustic signals at each of a plurality of downhole positions, the acoustic signals corresponding to compressional, shear, and Stoneley waves. Element 9: further comprising processing the frequency semblance information at different time-slices to identify shear wave arrival. Element 10: wherein the instructions causes the processor to perform WFSA by filtering the at least one digital waveform using a filter bank. Element 11: wherein the filter bank corresponds to a rectangular window and a split Hamming window. Element 12: wherein the instructions causes the processor to perform WFSA by converting windowed portions of the at least one digital waveform to the frequency domain. Element 13: wherein the instructions causes the processor to perform WFSA further comprises applying an objective function to the digital waveform. Element 14: wherein the instructions further causes the processor to combine the frequency semblance information at different time-slices to obtain a frequency semblance plot. Element 15: wherein the instructions further causes the processor to combine the frequency semblance information at different time-slices to obtain a time semblance plot. Element 16: wherein the instructions further causes the processor to display or store the slowness log. Element 17: wherein the acoustic signals correspond to compressional, shear, and Stoneley waves collected at each of a plurality of downhole positions. Element 18: wherein the instructions further causes the processor to identify a shear wave arrival based at least in part on the frequency semblance information at different time-slices. Element 19: further comprising the logging tool, wherein the logging tool is an acoustic logging tool to provide measurements of acoustic wave propagation speeds through the formation.

What is claimed is:

1. A method that comprises:
obtaining at least one digital waveform corresponding to acoustic signals collected by a logging tool deployed in a downhole environment;
performing windowed frequency spectra analysis (WFSA) on the at least one digital wavefoini to obtain frequency semblance information at different time-slices; and
deriving a slowness log as a function of position using the frequency semblance information.

2. The method of claim 1, wherein perfoiiiiing WFSA comprises filtering the at least one digital waveform using a filter bank.

3. The method of claim 2, wherein the filter bank corresponds to a rectangular window and a split Hamming window.

4. The method of claim 1, wherein performing WFSA further comprises converting windowed portions of the at least one digital waveform to the frequency domain.

5. The method of claim 1, wherein performing WFSA further comprises applying an objective function to the at least one digital waveform.

6. The method of claim 1, further comprising combining the frequency semblance information at different time-slices to obtain a frequency semblance plot.

7. The method of claim 1, further comprising combining the frequency semblance information at different time-slices to obtain a time semblance plot.

8. The method of claim 1, further comprising displaying or storing the slowness log.

9. The method of claim 1, further comprising collecting acoustic signals at each of a plurality of downhole positions, the acoustic signals corresponding to compressional, shear, and Stoneley waves.

10. The method of claim 1, further comprising processing the frequency semblance infoimation at different time-slices to identify shear wave arrival.

11. A system that comprises:
a display;
at least one processor in communication with the display;
at least one memory in communication with the at least one processor, the at least one memory storing instructions that, when executed, cause the at least one processor to:
obtain at least one digital waveform corresponding to acoustic signals collected by a logging tool deployed in a downhole environment;
perform windowed frequency spectra analysis (WFSA) on the at least one digital waveform to obtain frequency semblance information at different time-slices; and
derive a slowness log as a function of position using the frequency semblance information.

12. The system of claim 11, wherein the instructions cause the processor to perform WFSA by filtering the at least one digital waveform using a filter bank.

13. The system of claim 12, wherein the filter bank corresponds to a rectangular window and a split Hamming window.

14. The system of claim 11, wherein the instructions cause the processor to perform WFSA by converting windowed portions of the at least one digital waveform to the frequency domain.

15. The system of claim 11, wherein the instructions cause the processor to perform WFSA further comprises applying an objective function to the digital waveform.

16. The system of claim 11, wherein the instructions further cause the processor to combine the frequency semblance information at different time-slices to obtain a frequency semblance plot.

17. The system of claim 11, wherein the instructions further cause the processor to combine the frequency semblance information at different time-slices to obtain a time semblance plot.

18. The system of claim 11, wherein the instructions further cause the processor to display or store the slowness log.

19. The system of claim 11, wherein the acoustic signals correspond to compressional, shear, and Stoneley waves collected at each of a plurality of downhole positions.

20. The system of claim 11, wherein the instructions further cause the processor to identify a shear wave arrival based at least in part on the frequency semblance information at different time-slices.

21. The system of claim 11, further comprising the logging tool, wherein the logging tool is an acoustic logging tool to provide measurements of acoustic wave propagation speeds through the formation.
